(19) United States
(12) Patent Application Publication
(10) Pub. No.: US 2004/0244843 A1
(43) Pub. Date: Dec. 9, 2004

(54) Fuel tank for automobiles

(75) Inventors: Ryuichi Harigaya, Ibaraki (JP); Hiroshi Shimamura, Ibaraki (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: KYOSAN DENKI CO., LTD.

(21) Appl. No.: 10/859,563

(22) Filed: Jun. 3, 2004

(30) Foreign Application Priority Data
Jun. 4, 2003 (JP) P.2003-158981

(51) Int. Cl. F02M 37/04

(52) U.S. Cl. 137/574

(57) ABSTRACT

The invention is to offer a fuel tank for automobiles characterized by arranging a flange which is provided together with a pump holder for holding a fuel pump and a pipe shaped fuel supply hole.

### BACKGROUND OF THE INVENTION

The present invention relates to a structure of a fuel tank for supplying a fuel to an automobile engine.

In a fuel tank A of such as motorbikes as shown in FIGS. 5 and 6, a fuel supply hole B is fixedly provided as a pipe-shaped projection in an upper face of the fuel tank A for supplying a fuel from an outside. This is similar to, in automobiles, types of exposing the fuel tank A outside of a car body.

In addition, a main constituting part includes a fuel pump C as a delivery measure of supplying the fuel fed in the fuel tank A to the engine.

The fuel pump C is fixedly installed within the fuel tank A, and for this installation, a fixing flange D is furnished over an upper face of the fuel tank A to serve as a holding measure of the fuel pump C.

Therefore, since the flange D for holding the fuel pump is furnished as covering the upper face of the fuel tank A, it has a form also serving as a cover.

As mentioned above, the fuel supply hole B and the flange D for holding the fuel pump are furnished over the fuel tank A, but those are constituted as independent and separate members, respectively.

The fuel supply hole B projects outside of the fuel tank A as the pipe-shaped projection as mentioned above, and the projecting part placing inside of the fuel tank A is formed as the projection of a fuel oil supply pipe E of a length shown with “L” in FIG. 5.

For providing the above structure, the fuel tank A has necessitated to form an opening for the fuel supply hole B in the upper face thereof and another opening for fixedly catching the flange D for holding the fuel pump in different two positions. Further, since the fuel tank A is formed in the upper face with the openings at the two positions, the upper part cannot be used as a space for disposing other members or a useful space and a degree of designing freedom is restrained.

In case a sheet or a receiving box F is disposed above the flange D for holding the fuel pump, it is necessary to form the upper face of the fuel tank A to be a concave G as an intervening measure, and this measure is a factor of costing up.

Since the fuel oil supply pipe E has no length projecting or a short length projecting with respect to the inside of the fuel tank A, a fuel discharged from a supply gun H at supplying the fuel is forcibly jetted out on an oil level of fuel stored in the fuel tank A and is splashed, and therefore, splashes I are made to easily cause a gas of evaporated fuel, and it issues from an oil supply hole and this issue creates environmental problems.

### SUMMARY OF THE INVENTION

The invention is created in view of the above mentioned problems of the prior art, and has the under mentioned specific solving means.

An invention of a first aspect characterizes the fuel tank for automobiles, in that a flange is arranged on an opening formed in an upper face thereof, which flange is provided together with a pump holder for holding a fuel pump and a pipe shaped fuel supply hole.

An invention of a second aspect characterizes the fuel tank for automobiles, in that a pipe defining the fuel supply hole is formed as one body with the flange.

An invention of a third aspect characterizes the fuel tank for automobiles, in that the pipe defining the fuel supply hole is formed to extend toward an inside bottom of the fuel tank, and the fuel tank defining the supply hole is formed with an opening in an upper part of a side wall thereof.

An invention of a fourth aspect characterizes the fuel tank for automobiles, in that the pipe defining the fuel supply hole is formed to extend toward the inside bottom of the fuel tank, includes a check valve at a front end of an inside of the fuel tank, and is provided with an opening in a portion of the side wall being a setting point at a full tank of the fuel tank.

An invention of a fifth aspect characterizes the fuel tank for automobiles, in that the fuel pump is arranged vertically or laterally in an inside space of the pump holder.

### BRIEF DESCRIPTION OF THE DRAWINGS

FIG. 1A is a side and cross sectional view of the fuel tank for automobiles according to the invention;

FIG. 1B is a plan view of the flange portion of the fuel tank for automobiles according to the invention;

FIG. 2A is a side and cross sectional view of another embodiment of the fuel tank for automobiles according to the invention;

FIG. 2B is a side and cross sectional view of another embodiment of the opening portion of the filler pipe of the fuel tank for automobiles;

FIG. 2C is a cross sectional view seeing along A-A line shown in the above embodiment of the opening portion of the same;

FIG. 3 is a side and cross sectional view of a further embodiment of the fuel tank for automobiles according to the invention;

FIG. 4 is a side and cross sectional view of another embodiment of the fuel tank for automobiles according to the invention;

FIG. 5 is a schematically side and cross sectional view of the conventional example of the fuel tank for automobiles; and

FIG. 6 is a schematically front and cross sectional view of the conventional example of the fuel tank for automobiles.

### DETAILED DESCRIPTION OF THE PREFERRED EMBODIMENTS

The invention will be explained in line with embodiments.

[Embodiment 1]

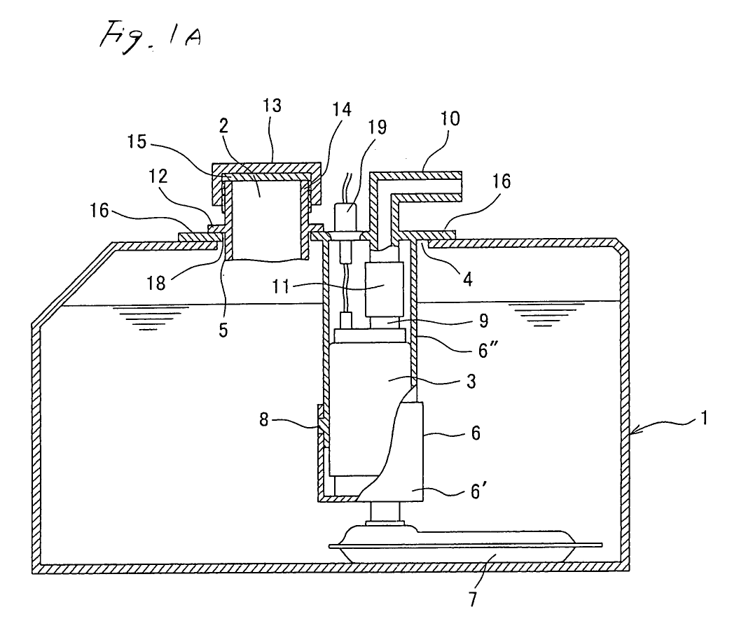

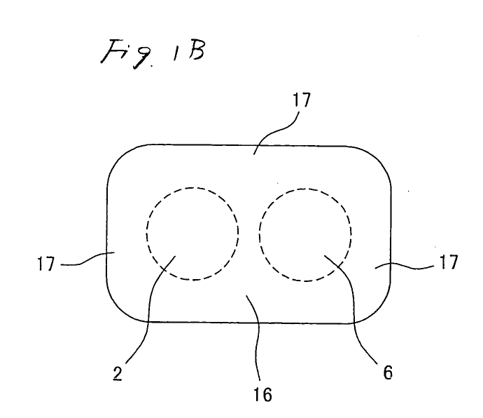

FIG. 1A shows one embodiment of the invention. Numeral 1 designates a fuel tank for automobiles, which is formed in an upper face thereof with an opening 4 for arranging a fuel supply hole 2 and a fuel pump 3. As the fuel supply hole 2, a cylindrical filler pipe 5 is formed to project from the upper face of the fuel tank 1 to an inside and an outside. A pump holder 6 is provided for installing the fuel pump 3 in the fuel tank 1. The pump holder 6 is formed with a holder 6′ at a lower side communicating with a suction filter 7 and a holder 6″ at an upper side fixed to an upper face of the fuel tank 1, and both are secured by engaging means 8 provided at a side face thereof.

In an inside space of the pump holder 6, there are respectively arranged the fuel pump 3 serving as a power source for discharging the fuel stored in the fuel tank 1, a discharging pipe 9 furnished on an upper end of the fuel pump 3 for feeding the fuel from the fuel pump 3 to an engine, and a connection tube 11 connecting a connecting pipe 10 at an engine side and the discharging pipe 9.

The fuel stored in the fuel tank 1 is filtered through the suction filter 7, passes the fuel pump 3, the discharging pipe 9, the connection tube 11 and the connecting pipe 10, and goes to the engine. The fuel is further filtered, if needed, through a high pressure filter equipped at an appropriate place between the fuel pump 3 and the connecting pipe 10.

At the outside of the fuel tank 1, the filler pipe 5 has a projection 12 on an outside wall and has a screwing part 14 at a front end for screwing a filler cap 13. Between the filler cap 13 and the screwing part 14, a sealing measure 15 is defined in either or both of the cap side 13 and the screwing side 14 in order to enable a sealing close of the filler pipe 5 by the filler cap 13.

On the upper opening 4 of the fuel tank 1, a flange 16 is arranged for installing the filler pipe 5 and the pump holder 6 within the fuel tank 1. The flange 16 is, as seen in FIGS. 1A and 1B, formed to be larger than the opening 4, and is secured to the fuel tank 1 such that the lower face of its periphery contacts a periphery of the upper face of the fuel tank 1.

The flange 16 is formed with a through-hole 18 for disposing the filler pipe 5 at its front placing within the fuel tank 1 and inserting the filler pipe 5 in the through-hole 18, and a projection 12 of the outside wall is fixedly set on the flange 16, thereby to secure filler pipe 5. Thus, the above mentioned structure turns out a fuel supply hole. The projection 12 may be in advance made integral with the flange 16, otherwise the flange 16 may be served as the projection 12.

The upper end of the upper side holder 6″ of the pump holder 6 is fixed on the lower face of the flange 16 provided together with the filler pipe 5, while, at the lower end thereof, the projection 8′ for the engaging means 8 formed in the other end side is in mesh with a concave 8″ for the engaging means 8 formed in the upper end side of the lower side holder 6′. Thus, both are secured by the engaging means 8. By securing both, the fuel pump 3 is stably disposed in the inside space of the pump holder 6.

The flange 16 is fixed to the connecting pipe 10, and the connecting pipe is connected at its inside front end to the connection tube 11 continuing to the discharging pipe 9 and the fuel pump 3. The connecting pipe 10 extends to the engine. Numeral 9 designates an electrically conductive connector.

[Embodiment 2]

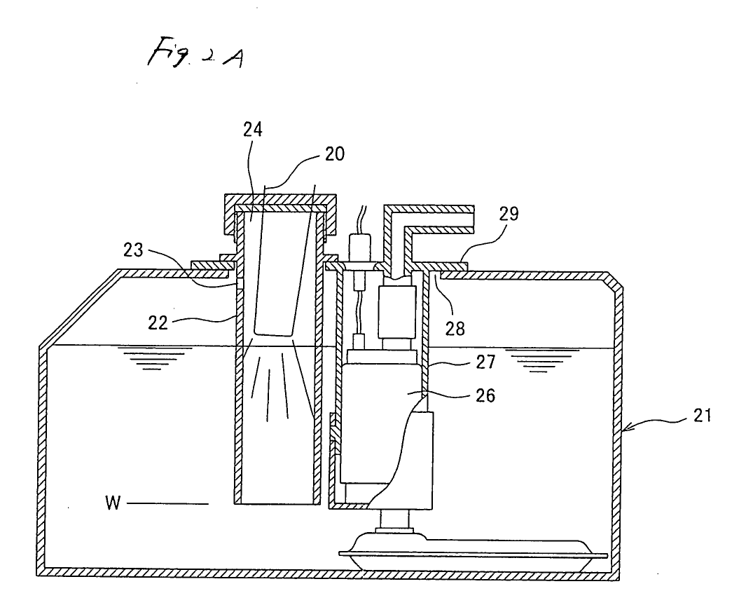

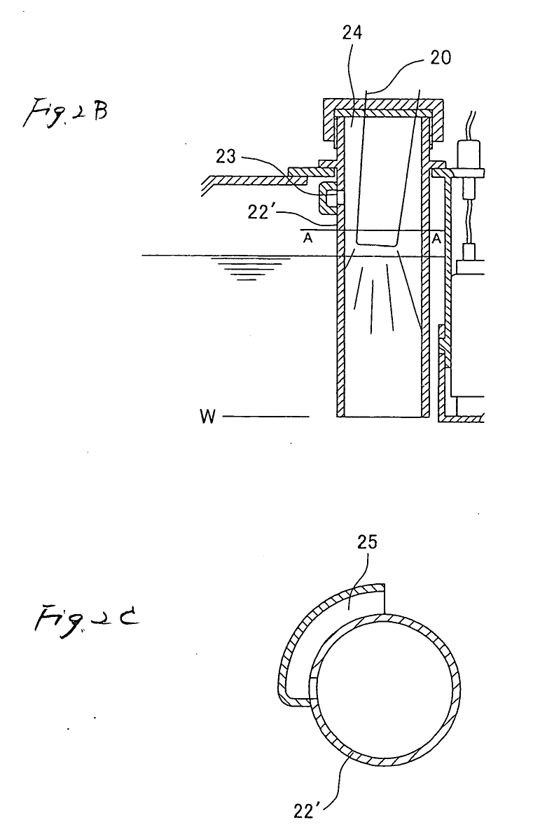

FIG. 2A is a cross sectional view of another embodiment of the invention showing an oil supplying condition where an oil supply gun 20 is inserted in a filler pipe 22 secured within the fuel tank 21.

The filler pipe 22 extends toward an inside bottom of a fuel tank 21.

By forming the filler pipe 22 to extend, the fuel forcibly jetted when supplying the fuel oil into the fuel tank 21 collides with a circumference of the inside wall of the filler pipe 22 and its force is weakened, so that generation of splashes caused by colliding with the oil level of fuel can be reduced and occurrence of a gas of evaporated fuel can be suppressed.

The filler pipe 22 is formed with an opening 23 at an upper side in the fuel tank 21. The opening 23 is for preventing an inner pressure from heightening within the fuel tank when supplying the fuel oil, and the opening 23 communicates with an insertion hole 24 of a supply gun 20 of the filler pipe 22, so that a compressed air can be escaped into an air.

The opening 23 avoids a rapid rise of an air pressure within the fuel tank 21 in that an oil level reaches W in the drawing, and a blow-off of the fuel counterflowing from the insertion hole 24 through the filler pipe 22 by the rapid rise.

FIG. 2B is a side and cross sectional view of another embodiment of the opening 23 in the fuel pipe 22, and FIG. 2C is cross sectional and plan view along A-A line shown in FIG. 2B. A pipe-like passage 25 is formed as encircling a filler pipe 22′ continuously from the opening 23. The fuel gas adheres to the inside wall of the passage 25, but the adhering matter is liquidized and the fuel evaporated gas corresponding to an amount of liquidation is prevented from getting out of the fuel tank.

In FIG. 2A, numeral 26 is a fuel pump and 27 designates a pump holder holding a fuel pump 26, and the filler pipe 22 and the pump holder 27 are secured together to a flange 29 fixedly set on the circumference of an opening 28 formed in the upper face of the fuel tank 21.

[Embodiment 3]

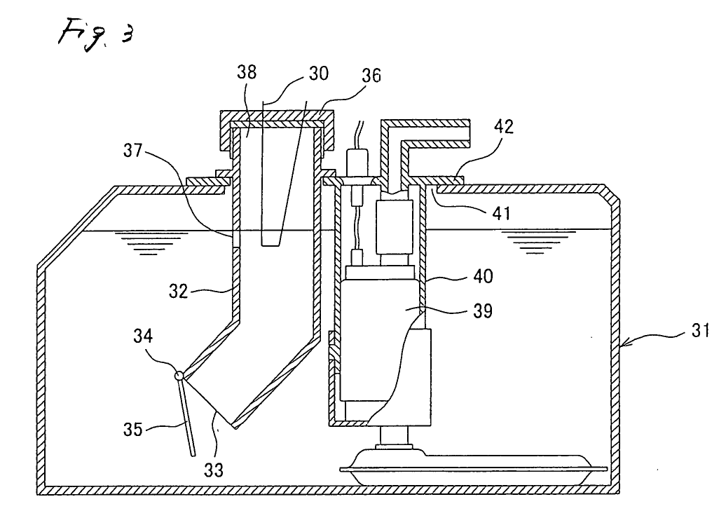

FIG. 3 is a cross sectional view of a further embodiment of the invention showing an oil supplying condition where an oil supply gun 30 is inserted in a filler pipe 32 secured within a fuel tank 31.

The filler pipe 32 extends toward the inside bottom of the fuel tank 31 and is formed to be bent or curved at its front side, and a front end opening 33 is formed to be oblique.

The opening 33 is equipped with a check valve 35 secured to a side wall of the front end of the filler pipe 32 turnably around an axis 34. The check valve 35 is always urged in the direction of closing an opening 33 by means as a spring.

The check valve 35 prevents the fuel in the fuel tank 31 from blowing off from the filler pipe 32 when a cap 36 is rapidly opened by such as the oil supply, or prevents the fuel from rushing out caused by the inner pressure when supplying the fuel.

When supplying the fuel, the check valve 35 is pushed to open from the inside to the outside by force at current velocity by the oil jetting, and the fuel is fed into the fuel tank 31.

The filler pipe 32 is formed with an opening 37 at an upper part within the fuel tank 31. The opening 37 communicates with an insertion hole 38 of a supply gun 30 to the filler pipe 32. By forming the opening 37, the rise of pressure is avoided in the fuel tank 31.

The fuel is supplied into the fuel tank 31, the oil level of fuel goes up and comes to the opening 37, and when the opening 37 is closed, at this moment the inner pressure within the fuel tank 31 rapidly rises, and the inner pressure is superior, by a fuel jetting force, to the force at current velocity when opening the check valve 35, and the check valve 35 is pushed at the outside of the filler pipe 32 in the fuel tank 31 and closes the opening 33.

By the rise of pressure, a fuel full tank detecting hole formed at the front end of the supply gun 30 is closed in the opening 31, and the oil feeding from the supply gun 30 is stopped.

Therefore, depending on a position of forming the opening 37, it is possible to specify a position of the oil level of fuel at the full tank.

Numeral 39 in the drawing is a fuel pump and 40 designates a pump holder holding the fuel pump 39, and the filler pipe 32 and the pump holder 40 are secured together to a flange 42 fixedly set on the circumference of an opening 41 formed in the upper face of the fuel tank 31.

[Embodiment 4]

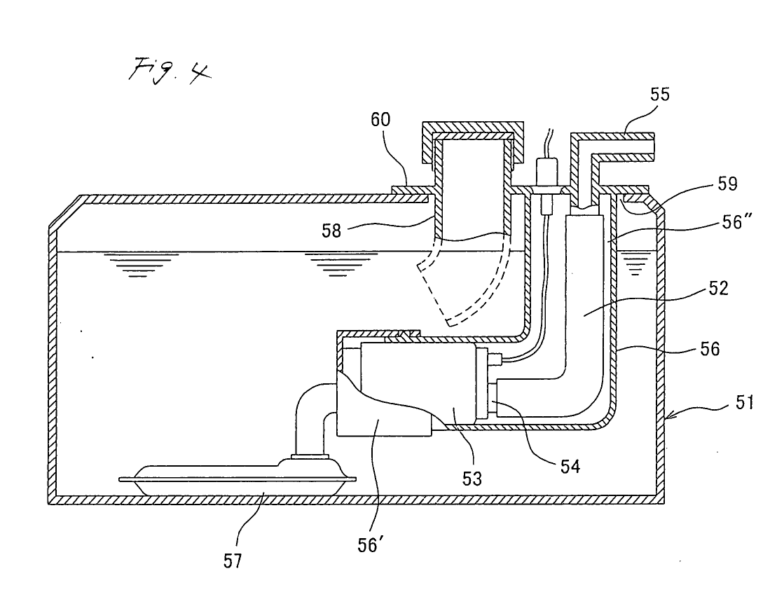

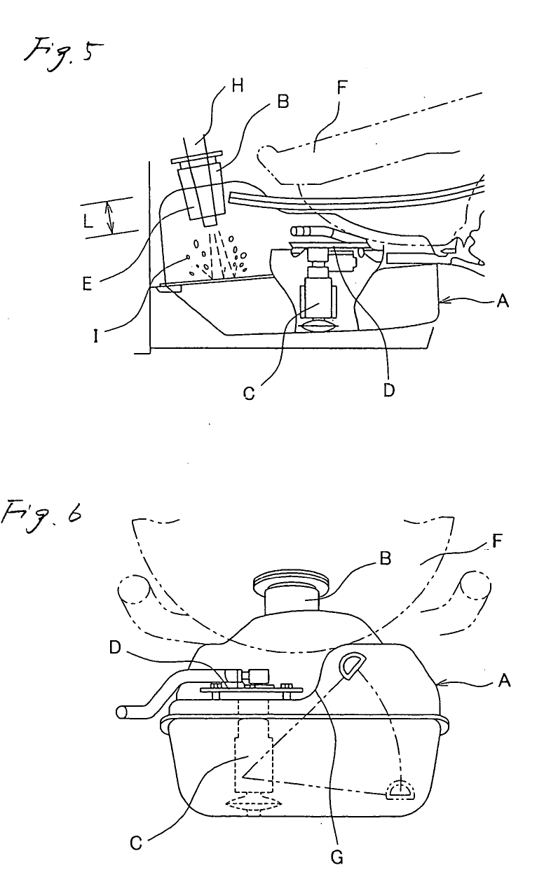

FIG. 4 shows another embodiment. In case a fuel tank 51 cannot secure a space enough in a height direction as a container in relation with other constituting elements of the automobile, possibly it is necessary to enlarge the space in a lateral direction.

In addition, for arranging still more high-pressure filters in a connection tube 52, a pipe wants to have an enough length.

In these cases, if disposing a fuel pump 53 in a lateral direction, a disposing limitation owing to the height of the fuel pump 53 is dissolved, and further, if disposing a discharging pipe 54 continuing to the fuel pump 53 at a position approaching the inside bottom of the fuel tank 51, an enough length of the connection tube 52 connecting a connecting pipe 55 can be secured.

The fuel pump 53 is supported by a pump holder 56, and if securing an upper side holder 56″ bent in L-shape to a lower side holder 56′ connected to a suction filter 57, a holding space is secured for disposing the fuel pump 53 laterally.

In the drawing, numeral 58 designates a filler pipe, and the pump holder 56 and the filler pipe 58 are secured together on a flange 60 fixed on the circumference of an opening 59 formed in the upper face of the fuel tank 51.

The invention of the first aspect provides the flange together with the pump holder and the fuel supply hole, enabling to reduce the production cost of parts and form the opening in the fuel tank in one position. Disposing elements to the flange concentrically, a degree of freedom utilizing the space in the upper face of the fuel tank is increased.

No ruggedness is necessary to be formed in the upper face of the fuel tank, and also in this point, the production cost may be saved.

The invention of the second aspect forms the pipe-shaped the fuel supply hole as one body with the flange, thereby to save a time of attaching to the fuel supply hole and make the handling easy.

The invention of the third aspect extends the pipe-shaped the fuel supply hole and forms the opening in the upper part thereof, thereby enabling to prevent generation of the fuel evaporated gas by splashing of the fuel.

The invention of the fourth aspect equips the check valve at the front end of the fuel supply hole and forms the opening at the position of determining the full tank, thereby to enable prevent the blow-off of the fuel from the fuel tank and automatically detect the full tank of the fuel oil.

The invention of the fifth aspect arrange the fuel pump laterally, thereby enabling to restrain the height of the fuel tank, so that the degree of designing freedom is increased. In addition, it is possible to sufficiently secure the disposing position of the high pressure filter.

What is claimed is:

1. A fuel tank for automobile, comprising:
a flange arranged on an opening formed in an upper face thereof, and
a pump holder for holding a fuel pump, the pump holder included in the flange, wherein
the flange is provided with a pipe shaped fuel supply hole.

2. The fuel tank for automobile as set forth in claim 1, wherein
a pipe defining the fuel supply hole is formed as one body with the flange.

3. The fuel tank for automobile as set forth in claim 1, wherein
the pipe defining the fuel supply hole is formed to extend toward an inside bottom of the fuel tank, and
the fuel tank defining the supply hole is formed with an opening in an upper part of a side wall thereof.

4. The fuel tank for automobile as set forth in claim 1, wherein
the pipe defining the fuel supply hole is formed to extend toward the inside bottom of the fuel tank, and includes a check valve at a front end thereof placing within the fuel tank, and is provided with an opening in a portion of the side wall being a setting point at a full tank.

5. The fuel tank for automobile as set forth in claim 1, wherein
the fuel pump is arranged vertically or laterally in an inside space of the pump holder.
